(19) United States
(12) Patent Application Publication
(10) Pub. No.: US 2025/0273366 A1
(43) Pub. Date: Aug. 28, 2025

(54) CABLE BRAIDED LAYER PROCESSING DEVICE AND METHOD

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/064,778

(22) Filed: Feb. 27, 2025

(30) Foreign Application Priority Data
Feb. 28, 2024 (CN) 202410224477.1

(51) Int. Cl. H01B 13/26; H01R 9/05

(52) U.S. Cl. CPC H01B 13/2606; H01R 9/0518

(57) ABSTRACT

A cable braided layer processing device comprises a fixture and a pair of roller brushes. The fixture includes a pair of fixture halves adapted to clamp onto an outer layer of a cable. The pair of roller brushes is adapted to fold the exposed braided layer of the cable backwards onto the fixture. When folding the braided layer, the braided layer of the cable enters between the pair of roller brushes and is folded backwards onto the fixture by rotating the pair of roller brushes.

### CROSS-REFERENCE TO RELATED APPLICATION

This application claims the benefit of Chinese Patent Application No. CN202410224477.1 filed on Feb. 28, 2024 in the State Intellectual Property Office of China, the whole disclosure of which is incorporated herein by reference.

### FIELD OF THE DISCLOSURE

The disclosure relates to a cable braided layer processing device and a method for processing cable braided layer using the cable braided layer processing device.

### BACKGROUND OF THE INVENTION

In the prior art, the folding and cutting of cable braided layer is usually done manually. This results in a very time-consuming and labor-intensive process, seriously reducing the processing efficiency of the cable braided layer.

### SUMMARY OF THE INVENTION

According to an embodiment of the present disclosure, a cable braided layer processing device comprises a fixture and a pair of roller brushes. The fixture includes a pair of fixture halves adapted to clamp onto an outer layer of a cable. The pair of roller brushes is adapted to fold the exposed braided layer of the cable backwards onto the fixture. When folding the braided layer, the braided layer of the cable enters between the pair of roller brushes and is folded backwards onto the fixture by rotating the pair of roller brushes.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative view of a cable braided layer processing device according to an exemplary embodiment of the present invention;

FIG. 2 shows an illustrative view of a fixture for a cable braided layer processing device according to an exemplary embodiment of the present invention;

FIG. 3 shows an illustrative view of the fixture of the cable braided layer processing device clamped on the outer layer of one end of the cable according to an exemplary embodiment of the present invention;

FIG. 4 shows an illustrative view of a pair of roller brushes of a cable braided layer processing device according to an exemplary embodiment of the present invention, wherein the pair of roller brushes is moved towards one end of the clamped cable;

FIG. 5 shows an illustrative view of a pair of roller brushes of a cable braided layer processing device according to an exemplary embodiment of the present invention, wherein the pair of roller brushes folds the exposed braided layer of the cable backwards onto a fixture;

FIG. 6 shows an illustrative view of the stamping sleeve of the cable braided layer processing device according to an exemplary embodiment of the present invention, wherein the stamping sleeve is moved towards one end of the fixture;

FIG. 7 shows an illustrative view of the stamping sleeve fitted to one end of the fixture of the cable braided layer processing device according to an exemplary embodiment of the present invention;

FIG. 8 shows an illustrative view of the stamping sleeve and fixture of a cable braided layer processing device according to an exemplary embodiment of the present invention, wherein the stamping sleeve and the fixture cooperate to cut the braided layer folded onto the fixture; and

FIG. 9 shows an illustrative perspective view of a cable processed by a cable braided layer processing device according to an exemplary embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a cable braided layer processing device is provided. The cable braided layer processing device comprises: a fixture comprising a pair of fixture halves for clamping onto the outer layer of a cable, and a pair of roller brushes used to fold the exposed braided layer of the cable backwards onto the fixture. When folding the braided layer, the braided layer of the cable enters between the pair of roller brushes and is folded backwards onto the fixture by rotating the pair of roller brushes.

According to another embodiment of the present invention, a cable braided layer processing method is provided. The method includes the steps of: providing the above cable braided layer processing device; clamping the outer layer of one end of a cable with a pair of fixture halves of fixture; driving the pair of roller brushes to move towards one end of the clamped cable, so that the exposed braided layer of the cable enters between the pair of roller brushes and is folded backwards onto the fixture by rotating the pair of roller brushes; moving the pair of roller brushes away; driving the stamping sleeve to move towards one end of the fixture to fit the stamping sleeve onto one end of the cylindrical part of the fixture; applying a predetermined axial punching force on the stamping sleeve fitted on the fixture to cut the braided layer folded onto the cylindrical part of the fixture through the circular cutting feature on the fixture and the mating circular cutting feature inside the stamping sleeve; moving the stamping sleeve away and release the fixture; and taking away the processed cable.

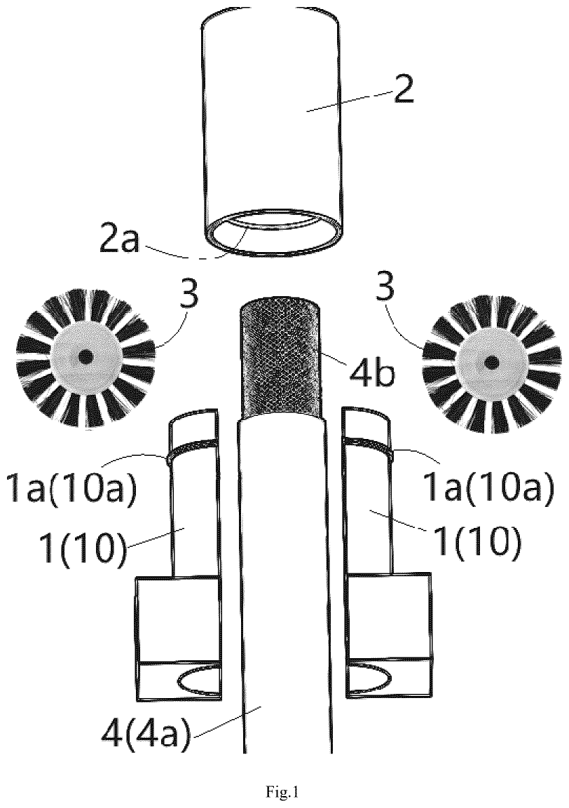

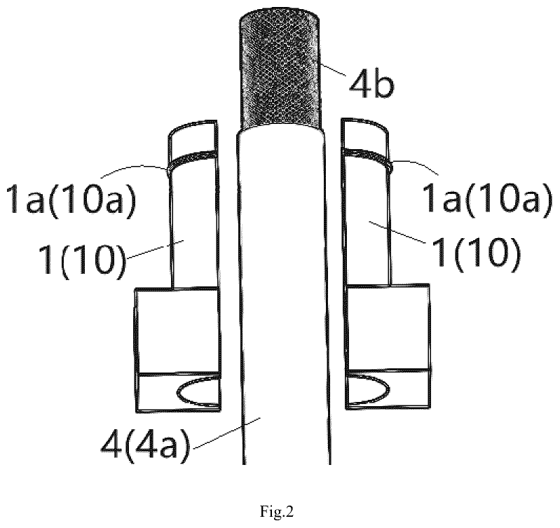

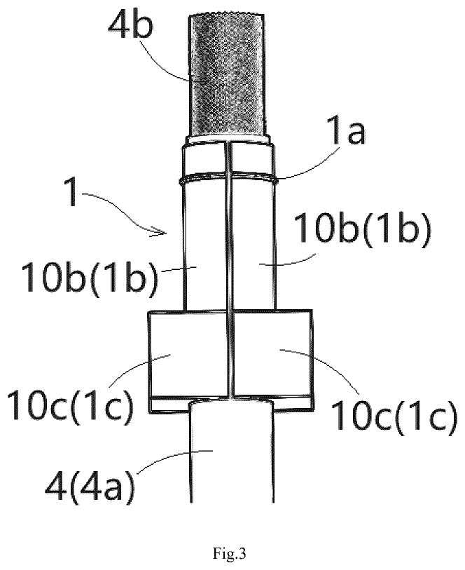

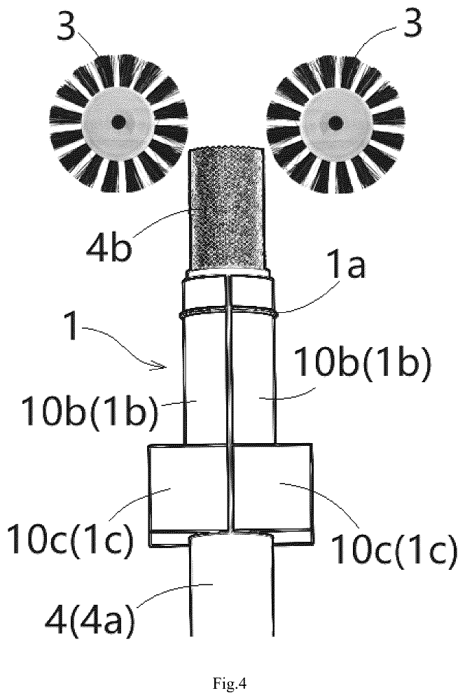

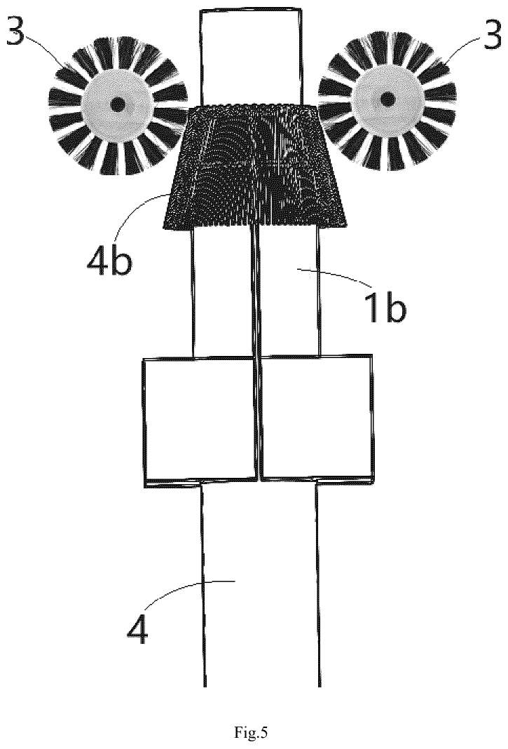

FIG. 1 shows an illustrative view of a cable braided layer processing device according to an exemplary embodiment of the present invention. FIG. 2 shows an illustrative view of fixture 1 of a cable braided layer processing device according to an exemplary embodiment of the present invention. FIG. 3 shows an illustrative view of the clamp 1 of the cable braided layer processing device according to an exemplary embodiment of the present invention, wherein the clamp 1 is clamped on the outer layer 4a of one end of the cable 4. FIG. 4 shows an illustrative view of a pair of roller brushes 3 of a cable braided layer processing device according to an exemplary embodiment of the present invention, wherein the pair of roller brushes 3 is moved towards one end of the clamped cable 4. FIG. 5 shows an illustrative view of a pair of roller brushes 3 of a cable braided layer processing device according to an exemplary embodiment of the present invention, wherein the pair of roller brushes 3 folds the exposed braided layer 4b of cable 4 backwards onto the fixture 1.

As shown in FIGS. 1-5, in an exemplary embodiment of the present invention, a cable braided layer processing device is disclosed. The cable braided layer processing device includes a fixture 1 and a pair of roller brushes 3. The fixture 1 includes a pair of fixture halves 10 for clamping onto the outer layer 4b of a cable 4. A pair of roller brushes 3 are used to fold the exposed braided layer 4b of cable 4 backwards onto the fixture 1. When folding the braided layer 4b, the braided layer 4b of cable 4 enters between the pair of roller brushes 3 and is folded backwards onto the fixture 1 by rotating the pair of roller brushes 3.

In the illustrated embodiment, the roller brush 3 can be rotated around an axis perpendicular to the axis of the clamped cable 4 and can be moved along the axis of the clamped cable 4. When folding the braided layer 4b, the roller brushes 3 are moved along the axial direction of the cable 4 towards the braided layer 4b and rotated around an axis perpendicular to the axial direction of the cable 4.

The cable braided layer processing device further comprises a movable base, a rotating driver, and a translating driver. The movable base can be moved along the axial direction of the cable 4 and the pair of roller brushes 3 are rotatably installed on the movable base. The rotary driver is installed on the movable base and connected to the roller brushes 3, used to drive the roller brushes 3 to rotate around the axis. The rotary driver can be, but is not limited to, a rotary motor. The translation driver is connected to the movable base and used to drive the movable base and the roller brushes 3 to move along the axial direction of the cable 4. The translation driver can be, but is not limited to, a linear motor.

The fixture half 10 has a semi cylindrical inner cavity suitable for mating with the cable 4. When the pair of fixture halves 10 are clamped onto the cable 4, the semi cylindrical inner cavities of the fixture halves 10 combine to form a complete cylindrical inner cavity, and the cable 4 is accommodated in the cylindrical inner cavity.

The fixture half 10 has a semi cylindrical part 10b. When the pair of fixture halves 10 are clamped onto the cable 4, the semi cylindrical parts 10b of the fixture halves 10 combine to form a complete cylindrical part 1b. The pair of roller brushes 3 are used to fold the braided layer 4b backwards onto the cylindrical part 1b of the fixture 1.

The fixture half 10 also has a half block portion 10c connected to the rear end of the semi cylindrical part 10b. When the pair of fixture halves 10 are clamped onto the cable 4, the half block portions 10c of the fixture halves 10 are combined into a complete block portion 1c. The block portion 1c of fixture 1 is suitable for being positioned in a positioning slot formed on a fixed seat (not shown) to locate and fix the fixture 1 and the cable 4 clamped by the fixture 1.

The cable braided layer processing device further comprises a fixed seat, on which a positioning slot suitable for cooperating with the block portion 1c of the fixture 1 is formed. The seat positions and fixes the fixture 1 to prevent it from being moved along its axis and rotated around its axis.

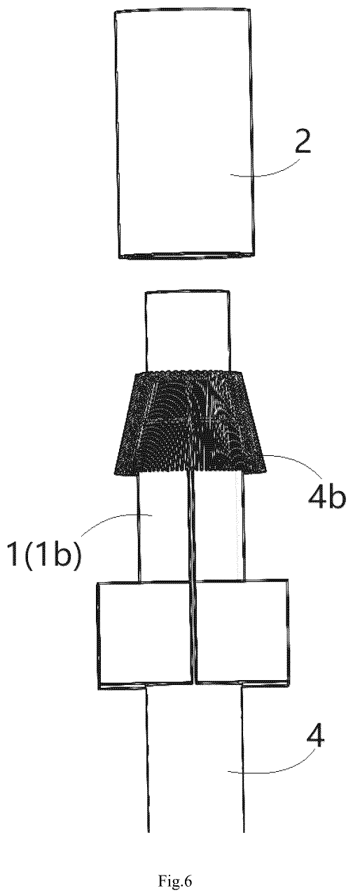

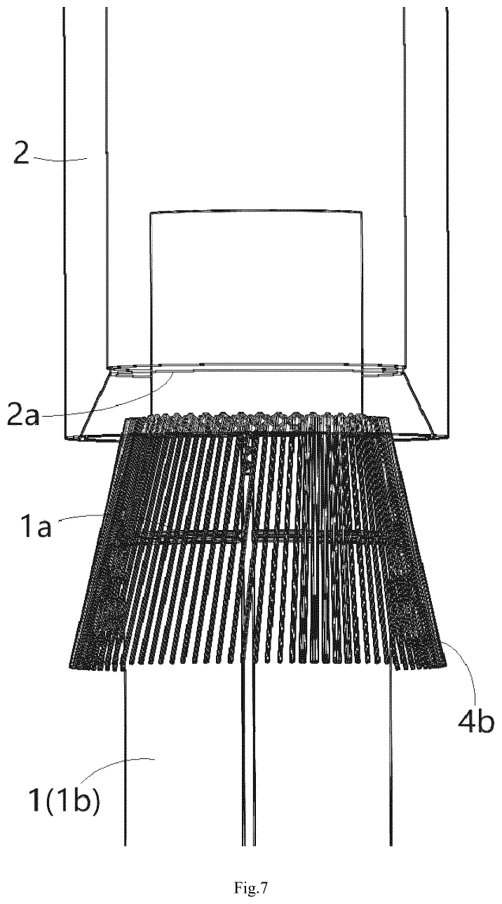

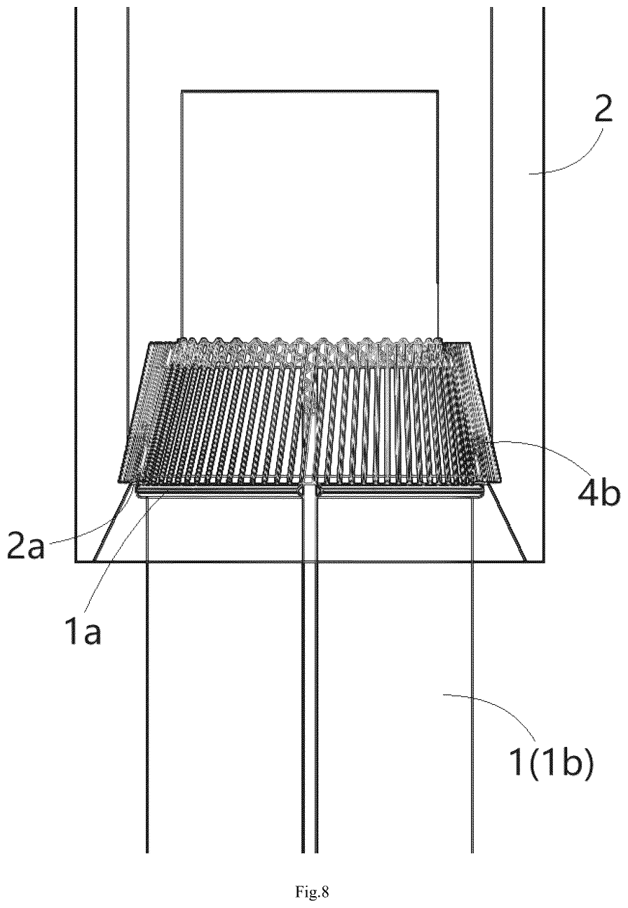

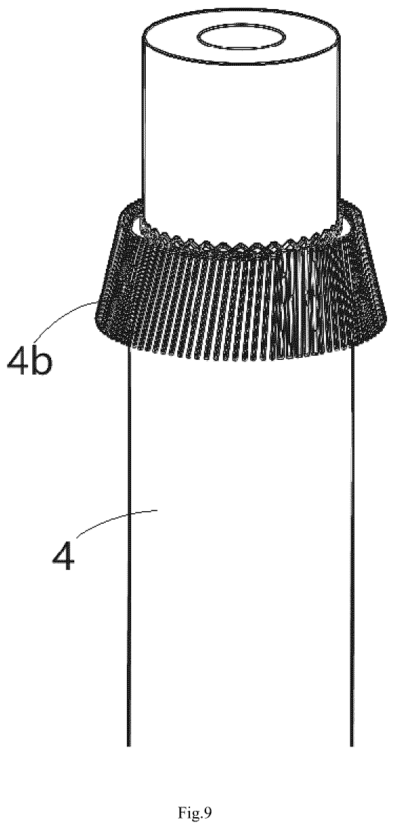

FIG. 6 shows an illustrative view of the stamping sleeve 2 of the cable braided layer processing device moving towards one end of the fixture 1 according to an exemplary embodiment of the present invention. FIG. 7 shows an illustrative view of the stamping sleeve 2 of the cable braided layer processing device assembled onto one end of the fixture 1 according to an exemplary embodiment of the present invention. FIG. 8 shows an illustrative view of the stamping sleeve 2 of the cable braided layer processing device according to an exemplary embodiment of the present invention, wherein the stamping sleeve 2 and the fixture 1 cooperate to cut the braided layer 4b folded onto the fixture 1. FIG. 9 shows an illustrative perspective view of a cable 4 processed by a cable braided layer processing device according to an exemplary embodiment of the present invention.

As shown in FIGS. 1-9, in the illustrated embodiment, a semi-circular cutting feature 10a is formed on the outer circumferential surface of the semi cylindrical part 10b of the fixture half 10. When the pair of fixture halves 10 are clamped onto the cable 4, the semi-circular cutting features 10a of the pair of fixture halves 10 combine to form a complete circular cutting feature la. The circular cutting feature la is used to cooperate with the mating circular cutting feature 2a inside the stamping sleeve 2 to cut the braided layer 4b folded onto the cylindrical part 1b of the fixture 1.

The cable braided layer processing device further comprises a stamped sleeve 2. The stamping sleeve 2 is suitable for fitting onto one end of the cylindrical part 1b of the fixture 1 and formed with an mating circular cutting feature 2a on its inner circumferential surface. When a predetermined axial punching force is applied to the stamping sleeve 2 mounted on the fixture 1, the circular cutting feature la and the mating circular cutting feature 2a cooperate with each other to cut the braided layer 4b folded onto the cylindrical part 1b of the fixture 1.

The circular cutting feature la is an annular convex rib formed on the outer circumferential surface of the cylindrical part 1b of the fixture 1, and the annular convex rib has a first annular cutting edge. The mating circular cutting feature 2a is formed on the inner circumferential surface of the stamping sleeve 2 as an annular step, and this annular step has a second annular cutting edge. The first annular cutting edge is used to cooperate with the second annular cutting edge to cut the braided layer 4b folded onto the cylindrical part 1b of the fixture 1.

The cable braided layer processing device further comprises a stamping cylinder, which is connected to the stamping sleeve 2 and used to drive the stamping sleeve 2 to move towards one end of the fixture 1 and apply a predetermined axial punching force on the stamping sleeve 2.

In another exemplary embodiment of the present invention, a cable braided layer processing method is also disclosed. The cable braided layer treatment method includes the following steps:

S10: Provide the aforementioned cable braided layer processing device;

S20: As shown in FIGS. 2 and 3, clamp the outer layer 4b at one end of cable 4 with the pair of fixture halves 10 of the fixture 1;

S30: As shown in FIGS. 4 and 5, drive the pair of roller brushes 3 to move towards one end of the clamped cable 4, so that the exposed braided layer 4b of the cable 4 enters between the pair of roller brushes 3 and is folded back onto the fixture 1 by rotating the pair of roller brushes 3;

S40: As shown in FIG. 6, move the pair of roller brushes 3 away;

S50: As shown in FIGS. 6 and 7, drive the stamping sleeve 2 to move towards one end of the fixture 1 to fit the stamping sleeve 2 onto one end of the cylindrical part 1b of the fixture 1;

S60: As shown in FIG. 8, apply a predetermined axial punching force on the stamping sleeve 2 fitted on the fixture 1 to cut the braided layer 4b folded onto the cylindrical part 1b of the fixture 1 through the circular cutting feature la on the fixture 1 and the mating circular cutting feature 2a inside the stamping sleeve 2;

S70: As shown in FIG. 9, move the stamping sleeve 2 away and release the fixture 1; and

S80: Take away the processed cable 4.

As shown in FIGS. 8 and 9, in the illustrated embodiment, the braided layer 4b after cutting has a predetermined length and a flat circular cutting surface.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A cable braided layer processing device, comprising:
a fixture comprising a pair of fixture halves for clamping onto the outer layer of a cable; and
a pair of roller brushes used to fold the exposed braided layer of the cable backwards onto the fixture, when folding the braided layer, the braided layer of the cable enters between the pair of roller brushes and is folded backwards onto the fixture by rotating the pair of roller brushes.

2. The cable braided layer processing device according to claim 1, wherein the roller brush is rotatable around an axis perpendicular to the axis of the clamped cable and can be moved along the axis of the clamped cable.

3. The cable braided layer processing device according to claim 2, wherein when folding the braided layer, the roller brush is moved along the axial direction of the cable towards the braided layer and is rotated around the axis perpendicular to the axial direction of the cable.

4. The cable braided layer processing device according to claim 3, further comprising a movable base adapted to move along the axial direction of the cable, the pair of roller brushes are rotatably installed on the movable base.

5. The cable braided layer processing device according to claim 4, further comprising a rotary driver installed on the movable base and connected to the roller brushes, the rotary driver adapted to drive the roller brushes to rotate around the axis.

6. The cable braided layer processing device according to claim 5, further comprising a translation driver connected to the movable base and adapted to drive the movable base and the roller brushes to move along the axial direction of the cable.

7. The cable braided layer processing device according to claim 1, wherein the fixture half has a semi cylindrical inner cavity suitable for fitting with the cable.

8. The cable braided layer processing device according to claim 7, wherein when the pair of fixture halves are clamped onto the cable, the semi cylindrical inner cavities of the pair of fixture halves combine to form a complete cylindrical inner cavity.

9. The cable braided layer processing device according to claim 8, wherein the cable is accommodated in the cylindrical inner cavity.

10. The cable braided layer processing device according to claim 1, wherein:
the fixture half has a semi-circular cylindrical part;
when the pair of fixture halves are clamped onto the cable, the semi cylindrical parts of the pair of fixture halves combine to form a complete cylindrical part; and
the pair of roller brushes are used to fold the braided layer backwards onto the cylindrical part of the fixture.

11. The cable braided layer processing device according to claim 10, wherein:
the fixture half also has a half block portion connected to the rear end of the semi cylindrical part;
when the pair of fixture halves are clamped onto the cable, the half block portions of the pair of fixture halves are combined into a complete block portion; and
the block portion of the fixture is adapted to be positioned in a positioning slot formed on a fixed seat to locate and fix the fixture and the cable clamped by the fixture.

12. The cable braided layer processing device according to claim 11, further comprising a fixed seat, on which the positioning slot suitable for fitting with the block portion of the fixture is formed, the positioning slot positions and fixes the fixture to prevent the fixture from being moved along its axial direction and rotated around its axis.

13. The cable braided layer processing device according to claim 10, wherein:
a semi-circular cutting feature is formed on the outer circumferential surface of the semi cylindrical part of the fixture half;
when the pair of fixture halves are clamped onto the cable, the semi-circular cutting features of the pair of fixture halves combine to form a complete circular cutting feature; and
the circular cutting feature is used to cooperate with a mating circular cutting feature inside a stamping sleeve to cut the braided layer folded onto the cylindrical part of the fixture.

14. The cable braided layer processing device according to claim 13, further comprising a stamping sleeve suitable for fitting onto one end of the cylindrical part of the fixture and formed with a mating circular cutting feature on its inner circumferential surface.

15. The cable braided layer processing device according to claim 14, wherein when a predetermined axial punching force is applied to the stamping sleeve mounted on the fixture, the circular cutting feature and the mating circular cutting feature cooperate with each other to cut the braided layer folded onto the cylindrical part of the fixture.

16. The cable braided layer processing device according to claim 15, wherein the circular cutting feature is an annular convex rib formed on the outer circumferential surface of the cylindrical part of the fixture, and the annular convex rib has a first annular cutting edge.

17. The cable braided layer processing device according to claim 16, wherein the mating circular cutting feature is formed as an annular step on the inner circumferential surface of the stamping sleeve, and the annular step has a second annular cutting edge.

18. The cable braided layer processing device according to claim 17, wherein the first annular cutting edge is cooperates with the second annular cutting edge to cut the braided layer folded onto the cylindrical part of the fixture.

19. The cable braided layer processing device according to claim 18, further comprising a stamping cylinder which is connected to the stamping sleeve and adapted to drive the stamping sleeve to move towards one end of the fixture and apply a predetermined axial punching force on the stamping sleeve.

20. A cable braided layer processing method comprising the following steps of:
S10: providing a cable braided layer processing device;
S20: clamping an outer layer of one end of a cable with a pair of fixture halves of a fixture of the device;
S30: driving a pair of roller brushes of the device to move towards one end of the clamped cable, so that the exposed braided layer of the cable enters between the pair of roller brushes and is folded backwards onto the fixture by rotating the pair of roller brushes;
S40: moving the pair of roller brushes away;
S50: driving a stamping sleeve of the device to move towards one end of the fixture to fit the stamping sleeve onto one end of a cylindrical part of the fixture;
S60: applying a predetermined axial punching force on the stamping sleeve fitted on the fixture to cut the braided layer folded onto the cylindrical part of the fixture through a circular cutting feature on the fixture and a mating circular cutting feature inside the stamping sleeve; and
S70: moving the stamping sleeve away and releasing the fixture; and
S80: taking away the processed cable.
